(19) United States
(12) Patent Application Publication
(10) Pub. No.: US 2026/0235429 A1
(43) Pub. Date: Aug. 13, 2026

(54) WATER AND ENERGY MONITORING COMPONENTS AND SYSTEMS AND METHODS OF USE THEREOF

(71) Applicant: SHOWER CANARY LIMITED, Witherlea, Blenheim (NZ)

(72) Inventors: Matthew BLACK, Witherlea, Blenheim (NZ); Hamish LAIRD, Diamond Harbour (NZ)

(73) Assignee: SHOWER CANARY LIMITED, Witherlea, Blenheim (NZ)

(21) Appl. No.: 19/151,520

(22) PCT Filed: Jan. 22, 2024
(86) PCT No.: PCT/IB2024/050570

§ 371 Date: Jul. 28, 2025

(30) Foreign Application Priority Data
Jan. 30, 2023 (NZ) 796765

(51) Int. Cl. G01F 15/063; G01D 4/00; G01D 11/26; G01D 21/02; G01F 1/66; G01F 15/18; G01K 1/02; G01K 1/024; G01K 1/14; G01K 13/02; G08B 7/06

(52) U.S. Cl. CPC G01F 15/063; G01D 4/002; G01D 11/26; G01D 21/02; G01F 1/662; G01F 15/185; G01K 1/024; G01K 1/028; G01K 1/146; G01K 13/026; G08B 7/06; G01D 2204/125; G01D 2204/14; G01D 2204/16; G01D 2204/18

(57) ABSTRACT

The present invention relates to components and systems for monitoring liquid and energy usage, and in particular for monitoring water usage. The present invention further relates to methods for monitoring liquid usage, or monitoring liquid and energy usage, by utilising these components or systems. The present invention also relates to components, system and methods for monitoring liquid flow and leakage, in particular water flow and leakage.

### FIELD

The present disclosure relates to water and energy monitoring systems, and the components for these systems, as well as methods for using the monitoring systems and components. The present disclosure also relates to liquid flow and leak detection systems, components for these systems and methods for using these systems, and in particular to water flow and leak detection systems.

### BACKGROUND

Water and power shortages are becoming more frequent throughout the world. This means that water and energy conservation are major issues for many states, cities, towns, and communities. Consumers are looking for ways to support water and energy conservation efforts, and to exert better control over water and energy resources and the costs associated with these resources.

Most water supply lines have a primary water meter. Similarly, power supply lines will have a primary power meter. However, these water and power meters are unlikely to be readily available or conveniently located for a user to observe. Absent, in particular, is the ability to monitor a specific parameter such as hot water usage. Even if a water or power meter can be accessed for viewing, the display is a simple continuous or cumulative gauge that does not allow monitoring and comparative assessments of real-time water and energy uses.

Furthermore, available water and energy meters do not have the capability to wirelessly transfer water use information to a remote display (or data collection/database) that is conveniently located for review by the user to allow and encourage water and energy conservation. In addition, available water and energy meters monitor household usage, without the ability to analyse individual components, such as water and energy use information from sinks, showers, baths, etc.

In many countries, average shower usage per person is approximately 8 minutes. Yet, government agencies and local councils are encouraging shower usage of 4 minutes or less. Most users struggle to monitor and improve their water and energy conservation. Simple timers (e.g., electronic timers) may not be suitable for the wet environment found in bathrooms, and cannot track data to assist with behaviour modification. Other devices (e.g., plumbed in or hardwired in) devices have significant costs and/or significant impacts on water flow quality.

Another concern is water leakage. Many water systems leak and the volume of water leaking out of water systems can be significant. For example, many cities have aging water reticulation systems. Over time, components of these systems, such as pipes, suffer from wear and corrosion. This leads to serious water leakage, which is both expensive and environmentally harmful to communities. Similarly, leaking water pipes can be a problem in buildings, schools, hospitals, and the like.

It is often very difficult to determine where a leak is originating from, particularly in large water systems such as city water mains, hospitals, and other such facilities. It is desirable to find the source of water leaks, which can then be remediated.

An associated issue is the need to detect water flow in pipes. Detection of water flow in pipes is part of the process for detecting leaks. In addition, there may be other circumstances when it is desired to detect water flow in pipes, such as pipe identification in a location where there are multiple pipes. Allowing water to flow via a sensor could correctly identify which pipe is the one being searched for. It may also be necessary in some situations to detect the flow and/or leakage of other liquids.

As such, there is an ongoing need for innovation in water and energy monitoring systems and apparatuses for such systems. There is also an ongoing need for innovation in liquid flow and liquid leak detections systems and apparatuses for such systems, and in particular for water flow and water leak detections systems and apparatuses.

### SUMMARY OF THE INVENTION

(1) In one aspect, the present invention provides a water and energy monitoring device comprising:
a sensor unit comprising an accelerometer and/or gyroscope and housing adapted to enclose the accelerometer and/or gyroscope,
wherein the sensor unit is adapted to be positioned on a water flow fitting,
wherein the accelerometer and/or gyroscope measures vibrations from the water flow fitting, and
wherein the vibrations from the water flow fitting correlate to water and energy usage by a user.

In various aspects:

The sensor unit comprises a gyroscope.

The water flow fitting is selected from the group consisting of: plumbing spouts, fillers, taps, necks, arms, heads, and roses.

The water flow fitting is selected from the group consisting of: shower necks, shower arms, shower heads, shower roses, and shower pipes.

The water flow fitting is selected from the group consisting of: water pipes and water tanks.

The sensor unit further comprises a temperature sensor.

The sensor unit further comprises at least one of: a power source, an on/off indicator, a wireless transmitter, and a microprocessor or microcontroller.

The power source comprises a battery.

The wireless transmitter comprises a Bluetooth transmitter.

The microprocessor or microcontroller is included in a printed circuit board.

The sensor unit includes a cinch adapted to hold the sensor unit on the water flow fitting.

The sensor unit includes a cinch holder adapted to allow adjustment and securement of the cinch.

The housing is water resistant or water proof.

(2) In one other aspect, the present invention provides a water and energy monitoring device comprising:
a hub unit comprising a wireless receiver to receive water usage data from a sensor unit, and a housing adapted to enclose the wireless receiver,
wherein the sensor unit comprises an accelerometer and/or a gyroscope,
wherein the sensor unit is adapted to be positioned on a water flow fitting,
wherein the accelerometer and/or gyroscope measures vibrations from the water flow fitting,
wherein the vibrations from the water flow fitting correlate to water and energy usage by a user,
wherein the sensor unit processes data regarding the water use, and
wherein the sensor unit wirelessly transmits the data to the hub unit.

In various aspects:

The sensor unit comprises a gyroscope.

The water flow fitting is selected from the group consisting of: plumbing spouts, fillers, taps, necks, arms, heads, and roses.

The water flow fitting is selected from the group consisting of: shower necks, shower arms, shower heads, shower roses, and shower pipes.

The water flow fitting is selected from the group consisting of: water pipes and water tanks.

The hub unit further comprises a digital display.

The hub unit further comprises a humidity sensor.

The hub unit further comprises at least one of: a power transformer, a speaker or other audio device, an on/off indicator, and a microprocessor or microcontroller.

The transformer is a 240 volt to 5 volt transformer.

The digital display is an OLED, LED, or LCD display.

The on/off indicator is a LED light or vibrator.

The wireless transmission receiver is Bluetooth receiver.

The wireless transmitter is a WiFi, 4G or IoT transmitter.

The microprocessor or microcontroller is included in a printed circuit board.

The housing is water resistant or water proof.

The hub unit is powered by a charger (e.g., 240 volt/5 volt charger).

The hub unit is wall mounted.

The hub unit is powered by electrical engagement with an electrical socket.

The hub unit is powered by electrical engagement with a docking station.

(3) In one further aspect, the present invention provides a water and energy monitoring system comprising:
a sensor unit according to any previous aspect, and
a hub unit according to any previous aspect,
   wherein the accelerometer and/or gyroscope of the sensor unit is/are adapted to measure vibrations from the water flow fitting,
   wherein the vibrations from the water flow fitting correlate to water and energy usage by a user,
   wherein the sensor unit processes data regarding the water use by the user,
   wherein the sensor unit wirelessly transmits the data to the hub unit,
   wherein the hub unit displays the data regarding the water use,
   wherein hub unit wirelessly transmits the data to remote data storage,
   wherein the remote data storage is able to be accessed by an electronic device.

In various aspects:

The sensor unit comprises a gyroscope.

The water flow fitting is selected from the group consisting of: plumbing spouts, fillers, taps, necks, arms, heads, and roses.

The water flow fitting is selected from the group consisting of: shower necks, shower arms, shower heads, shower roses, and shower pipes.

The water flow fitting is selected from the group consisting of: water pipes and water tanks.

The hub unit displays one or more of: length of time for current water usage, length of time for recent water usage, target time period for water usage, amount of time exceeding the target time period for water usage.

The hub unit provides an auditory signal indicating one or more of: length of time for current water usage, length of time for recent water usage, target time period for water usage, amount of time exceeding the target time period for water usage.

The audio signal is selected from a voice prompt and an alarm.

The hub unit provides a visual signal indicating one or more of: amount of time of water usage, target time period for water usage, amount of time exceeding the target time period for water usage.

The visual signal is selected from one or more of: a colour, a change in colour, a steady light, a flashing light, a symbol, and a picture.

The remote data storage source is cloud storage or a website.

The electronic device is selected from the group consisting of a smart phone, a tablet, and a PC.

The electronic device comprises a program or application software for processing and displaying the data in a user interface.

The user interface provides information to the user including one or more of:
length of time for current water usage
length of time for recent water usage
average time of water usage per water use event
length of time of water usage per day, per week, per month, and/or per year
number of water usage events per day, per week, per month, and/or per year
water usage time exceeding a preset value
estimated water cost for water usage
estimated energy cost for water usage
estimated CO₂e from energy
water cost exceeding a preset value
energy cost exceeding a preset value
cost of water usage per day, per week, per month, and/or per year
cost of energy from water usage per day, per week, per month, and/or per year
water cost savings per day, per week, per month, and/or per year, and
energy cost savings per day, per week, per month, and/or per year.

(4) In yet one further aspect, the present invention provides a method for monitoring water usage comprising:
measuring vibrations from a water flow fitting, wherein the vibrations are measured by an accelerometer and/or a gyroscope enclosed in a sensor unit, wherein the sensor unit is positioned on the water flow fitting, and wherein the vibrations from the water flow fitting correlate to water usage by a user,
with the sensor unit, processing data regarding the water use by the user,
transmitting the data wirelessly from the sensor unit to a hub unit, the hub unit comprising a wireless receiver to receive water usage data from a sensor unit, and the hub unit being adapted to enclose the wireless receiver,
displaying the data regarding the water use on the hub unit, and
transmitting the data wirelessly or via IoT from the hub unit to remote data storage.

In various aspects:

The sensor unit comprises a gyroscope.

The water flow fitting is selected from the group consisting of: plumbing spouts, fillers, taps, necks, arms, heads, and roses.

The water flow fitting is selected from the group consisting of: shower necks, shower arms, shower heads, shower roses, and shower pipes.

The water flow fitting is selected from the group consisting of: water pipes and water tanks.

The displaying shows one or more of: length of time for current water usage, length of time for recent water usage, target time period for water usage, amount of time exceeding the target time period for water usage.

The displaying is accompanied by an auditory signal indicating one or more of: length of time for current water usage, length of time for recent water usage, target time period for water usage, amount of time exceeding the target time period for water usage.

The audio signal is selected from a voice prompt and an alarm.

The displaying is accompanied by a visual signal indicating one or more of: amount of time of water usage, target time period for water usage, amount of time exceeding the target time period for water usage.

The visual signal is selected from one or more of: a colour, a change in colour, a steady light, a flashing light, a symbol, and a picture.

The remote data storage source is cloud storage or a website.

The electronic device is selected from the group consisting of a smart phone, a tablet, and a PC.

The electronic device comprises a program or application software for processing and displaying the data in a user interface.

The user interface provides information to the user including one or more of:
length of time for current water usage
length of time for recent water usage
average time of water usage per water use event
length of time of water usage per day, per week, per month, and/or per year
number of water usage events per day, per week, per month, and/or per year
water usage time exceeding a preset value
estimated water cost for water usage
water cost exceeding a preset value
cost of water usage per day, per week, per month, and/or per year
water cost savings per day, per week, per month, and/or per year.

(5) In still one further aspect, the present invention provides a method for monitoring water and energy usage comprising:
measuring vibrations from a water flow fitting, wherein the vibrations are measured by an accelerometer and/or gyroscope enclosed in a sensor unit, wherein the sensor unit is positioned on the water flow fitting, and wherein the vibrations from the water flow fitting correlate to water and energy usage by a user,
with the sensor unit, processing data regarding the water use by the user,
transmitting the data wirelessly from the sensor unit to a hub unit, the hub unit comprising a wireless receiver to receive water usage data from a sensor unit, and the hub unit being adapted to enclose the wireless receiver,
displaying the data regarding the water use on the hub unit, and
transmitting the data wirelessly from the hub unit to remote data storage.

In various aspects:

The sensor unit comprises a gyroscope.

The water flow fitting is selected from the group consisting of: plumbing spouts, fillers, taps, necks, arms, heads, and roses.

The water flow fitting is selected from the group consisting of: shower necks, shower arms, shower heads, shower roses, and shower pipes.

The water flow fitting is selected from the group consisting of: water pipes and water tanks.

The displaying shows one or more of: length of time for current water usage, length of time for recent water usage, target time period for water usage, amount of time exceeding the target time period for water usage.

The displaying is accompanied by an auditory signal indicating one or more of: length of time for current water usage, length of time for recent water usage, target time period for water usage, amount of time exceeding the target time period for water usage.

The audio signal is selected from a voice prompt and an alarm.

The displaying is accompanied by a visual signal indicating one or more of: amount of time of water usage, target time period for water usage, amount of time exceeding the target time period for water usage.

The visual signal is selected from one or more of: a colour, a change in colour, a steady light, a flashing light, a symbol, and a picture.

The remote data storage source is cloud storage or a website.

The electronic device is selected from the group consisting of a smart phone, a tablet, and a PC.

The electronic device comprises a program or application software for processing and displaying the data in a user interface.

The program or application software calculates energy usage levels based on water usage levels.

The user interface provides information to the user including one or more of:
length of time for current water usage
length of time for recent water usage
average time of water usage per water use event
length of time of water usage per day, per week, per month, and/or per year
number of water usage events per day, per week, per month, and/or per year
water usage time exceeding a preset value
estimated water cost for water usage
estimated energy cost for water usage
estimated CO₂e from energy
water cost exceeding a preset value
energy cost exceeding a preset value
cost of water usage per day, per week, per month, and/or per year
cost of energy from water usage per day, per week, per month, and/or per year
water cost savings per day, per week, per month, and/or per year, and
energy cost savings per day, per week, per month, and/or per year.

(6) In one still further aspect, the present invention provides a liquid monitoring device comprising:
one or more sensor units, each sensor unit comprising an accelerometer and/or gyroscope and housing adapted to enclose the accelerometer and/or gyroscope,
wherein each sensor unit is adapted to be positioned on a liquid flow fitting or liquid-containing vessel,
wherein the accelerometer and/or gyroscope is/are adapted to measure vibrations from the or each liquid flow fitting or the liquid-containing vessel, and
wherein the vibrations from the or each liquid flow fitting or the liquid-containing vessel correlate to liquid flowing through the liquid flow fitting or fittings or in the liquid-containing vessel.

In various aspects:

The liquid is water.

The vibrations from the or each liquid flow fitting or liquid-containing vessel correlate to liquid flowing through the liquid flow fitting or fittings or the liquid-containing vessel, the flow of liquid indicating a leak.

The liquid flow fitting(s) is/are selected from the group consisting of: pipes and hoses.

The liquid-containing vessels are tanks.

The sensor unit comprises a gyroscope.

The sensor unit further comprises a temperature sensor.

The sensor unit further comprises at least one of: a power source, an on/off indicator, a wireless transmitter, and a microprocessor or microcontroller.

The power source comprises a battery.

The wireless transmitter comprises a Bluetooth transmitter.

The microprocessor or microcontroller is included in a printed circuit board.

The sensor unit includes a cinch adapted to hold the sensor unit on the liquid flow fitting or the liquid-containing vessel.

The sensor unit includes a cinch holder adapted to allow adjustment and securement of the cinch.

The housing is liquid resistant or liquid proof.

(7) In one still further aspect, the present invention provides a liquid monitoring device comprising:
one or more sensor units,
a central unit comprising a wireless receiver to receive liquid flow data from the one or more sensor units, and a housing adapted to enclose the wireless receiver,
wherein each sensor unit comprises an accelerometer and/or a gyroscope,
wherein each sensor unit is adapted to be positioned on a liquid flow fitting or a liquid-containing vessel,
wherein the accelerometer and/or gyroscope is/are adapted to measure vibrations from the or each liquid flow fitting or the liquid-containing vessel,
wherein the vibrations from the or each liquid flow fitting or the liquid-containing vessel correlate to liquid flowing through the liquid flow fitting or fittings or in the liquid-containing vessel,
wherein each sensor unit processes data regarding the liquid flow, and
wherein each sensor unit wirelessly transmits the data to the central unit.

In various aspects:

The liquid is water.

The vibrations from the or each liquid flow fitting or liquid-containing vessel correlate to liquid flowing through the liquid flow fitting or fittings or the liquid-containing vessel, the flow of liquid indicating a leak.

The liquid flow fitting(s) is/are selected from the group consisting of: pipes and hoses.

The liquid-containing vessels are tanks.

The sensor unit comprises a gyroscope.

The central unit further comprises a digital display.

The central unit further comprises a humidity sensor.

The central unit further comprises at least one of: a power transformer, a speaker or other audio device, an on/off indicator, and a microprocessor or microcontroller.

The transformer is a 240 volt to 5 volt transformer.

The digital display is an OLED, LED, or LCD display.

The on/off indicator is a LED light or vibrator.

The wireless transmission receiver is Bluetooth receiver.

The wireless transmitter is a WiFi, 4G or IoT transmitter.

The microprocessor or microcontroller are included in a printed circuit board.

The housing is liquid resistant or liquid proof.

The central unit is powered by a charger (e.g., 240 volt/5 volt charger).

The central unit is wall mounted.

The central unit is powered by electrical engagement with an electrical socket.

The central unit is powered by electrical engagement with a docking station.

(8) In one further aspect, the present invention provides a liquid monitoring system comprising:
a sensor unit according to either of the previous aspects (6) or (7), and
a central unit according to either of the previous aspects (6) or (7),
wherein the accelerometer and/or gyroscope of the or each sensor unit is/are adapted to measure vibrations from the liquid flow fitting or fittings or the liquid-containing vessel,
wherein the vibrations from the liquid flow fitting or fittings or the liquid-containing vessel correlate to liquid flowing through the liquid flow fitting or fittings or in the liquid-containing vessel,
wherein each sensor unit processes data regarding the flow of liquid,
wherein each sensor unit wirelessly transmits the data to the central unit,
wherein the central unit displays the data regarding the flow of liquid,
wherein the central unit wirelessly transmits the data to remote data storage,
wherein the remote data storage is able to be accessed by an electronic device.

In various aspects:

The liquid is water.

The vibrations from the or each liquid flow fitting or liquid-containing vessel correlate to liquid flowing through the liquid flow fitting or fittings or the liquid-containing vessel, the flow of liquid indicating a leak.

The liquid flow fitting(s) is/are selected from the group consisting of: pipes and hoses.

The liquid-containing vessels are tanks.

The sensor unit comprises a gyroscope.

The central unit displays one or more of: length of time for current liquid flow, length of time for recent liquid usage, target time period for liquid usage, amount of time exceeding the target time period for liquid usage.

The central unit provides an auditory signal indicating one or more of: length of time for current liquid flow, length of time for recent liquid flow, target time period for liquid usage, amount of time exceeding the target time period for liquid usage.

The audio signal is selected from a voice prompt and an alarm.

The central unit provides a visual signal indicating one or more of: amount of time liquid has been flowing, target time period for flow of liquid, amount of time exceeding the target time period for liquid flow.

The visual signal is selected from one or more of: a colour, a change in colour, a steady light, a flashing light, a symbol, and a picture.

The remote data storage source is cloud storage or a website.

The electronic device is selected from the group consisting of a smart phone, a tablet, and a PC.

The electronic device comprises a program or application software for processing and displaying the data in a user interface.

The user interface provides information to the user including one or more of:
length of time for current liquid usage
length of time for recent liquid usage
average time of liquid usage per water use event
length of time of liquid usage per day, per week, per month, and/or per year
number of water usage events per day, per week, per month, and/or per year
liquid usage time exceeding a preset value.

(9) In yet one further aspect, the present invention provides a method for monitoring water flow comprising:
measuring vibrations from one or more liquid flow fittings or a liquid-containing vessel, wherein the vibrations are measured by an accelerometer and/or a gyroscope enclosed in one or more sensor units, wherein each sensor unit is positioned on the liquid flow fitting or the liquid-containing vessel, and wherein the vibrations from the or each liquid flow fitting or the liquid-containing vessel correlate to the flow of liquid,
with the or each sensor unit processing data regarding the flow of liquid,
transmitting the data wirelessly from the or each sensor unit to a central unit, the central unit comprising a wireless receiver to receive liquid flow data from each sensor unit, and the central unit being adapted to enclose the wireless receiver,
displaying the data regarding the flow on the central unit, and
transmitting the data wirelessly or via IoT from the central unit to remote data storage.

In various aspects:

The liquid is water.

The vibrations from the or each liquid flow fitting or liquid-containing vessel correlate to liquid flowing through the liquid flow fitting or fittings or the liquid-containing vessel, the flow of liquid indicating a leak.

The liquid flow fitting(s) is/are selected from the group consisting of: pipes and hoses.

The liquid-containing vessels are tanks.

The sensor unit comprises a gyroscope.

The central unit displays one or more of: length of time for current liquid flow, length of time for recent liquid usage, target time period for liquid usage, amount of time exceeding the target time period for liquid usage.

The central unit provides an auditory signal indicating one or more of: length of time for current liquid flow, length of time for recent liquid flow, target time period for liquid usage, amount of time exceeding the target time period for liquid usage.

The audio signal is selected from a voice prompt and an alarm.

The central unit provides a visual signal indicating one or more of: amount of time liquid has been flowing, target time period for flow of liquid, amount of time exceeding the target time period for liquid flow.

The visual signal is selected from one or more of: a colour, a change in colour, a steady light, a flashing light, a symbol, and a picture.

The remote data storage source is cloud storage or a website.

The electronic device is selected from the group consisting of a smart phone, a tablet, and a PC.

The electronic device comprises a program or application software for processing and displaying the data in a user interface.

The user interface provides information to the user including one or more of:
length of time for current liquid usage
length of time for recent liquid usage
average time of liquid usage per water use event
length of time of liquid usage per day, per week, per month, and/or per year
number of liquid usage events per day, per week, per month, and/or per year
liquid usage time exceeding a preset value.

The foregoing brief summary broadly describes the features and technical advantages of certain embodiments. Further technical advantages will be described in the detailed description that follows.

Novel features that are believed to be characteristic of the invention will be better understood from the detailed description provided in this specification. The figures and exemplifications are intended to help illustrate the invention or assist with developing an understanding of the invention and are not intended to limit the scope of the invention in any way.

### BRIEF DESCRIPTION OF THE DRAWINGS

FIG. 1A: shows a front perspective view (with shading) of a hub unit according to an aspect of the present disclosure.

FIG. 1B: shows a front perspective view of a hub unit according to an aspect of the present disclosure.

FIG. 1C: shows a front view of the hub unit shown in FIG. 1B.

FIG. 1D: shows a back perspective view of the hub unit shown in FIG. 1B.

FIG. 1E: shows a right side view of the hub unit shown in FIG. 1B.

FIG. 1F: shows a left side view of the hub unit shown in FIG. 1B.

FIG. 1G: shows a top view of the hub unit shown in FIG. 1B.

FIG. 1H: shows a bottom view of the hub unit shown in FIG. 1B.

FIG. 2A: shows a front perspective view (with shading) of a sensor unit according to an aspect of the present disclosure.

FIG. 2B: shows a front perspective view of a sensor unit according to an aspect of the present disclosure.

FIG. 2C: shows a bottom perspective view of the sensor unit shown in FIG. 2B.

FIG. 2D: shows a top view of the sensor unit shown in FIG. 2B.

FIG. 2E: shows a front view of the sensor unit shown in FIG. 2B.

FIG. 2F: shows a back view of the sensor unit shown in FIG. 2B.

FIG. 2G: shows a left view of the sensor unit shown in FIG. 2B.

FIG. 2H: shows a right view of the sensor unit shown in FIG. 2B.

FIG. 3: shows a schematic of a system according to an aspect of the present disclosure.

FIG. 4A: shows a front view of a docking station according to an aspect of the present disclosure.

FIG. 4B: shows a right side view of the docking station shown in FIG. 4A.

FIG. 4C: shows a left side view of the docking station shown in FIG. 4A.

FIG. 4D: shows a top view of the docking station shown in FIG. 4A.

FIG. 4E: shows a bottom view of the docking station shown in FIG. 4A.

FIG. 4F: shows a top perspective view of the docking station shown in FIG. 4A.

FIG. 4G: shows a bottom perspective view of the docking station shown in FIG. 4A.

FIG. 5A: shows a front perspective view of a hub unit according to an aspect of the present disclosure.

FIG. 5B: shows a back perspective view of the hub unit shown in FIG. 5A.

FIG. 5C: shows a front view of the hub unit shown in FIG. 5A.

FIG. 5D: shows a top view of the hub unit shown in FIG. 5A.

FIG. 5E: shows a bottom view of the hub unit shown in FIG. 5A.

FIG. 5F: shows a right side view of the hub unit shown in FIG. 5A.

FIG. 5G: shows a left side view of the hub unit shown in FIG. 5A.

FIGS. 6A-6B: show a schematic of a system according to an aspect of the present disclosure. In FIG. 6A, the hub unit is not docked at the docking station. In FIG. 6B, the hub unit is docked at the docking station.

FIG. 7: show a schematic of a system according to an aspect of the present disclosure.

### DETAILED DESCRIPTION

The following description sets forth numerous exemplary configurations, parameters, and the like. It should be recognised, however, that such description is not intended as a limitation on the scope of the present invention but is instead provided as a description of exemplary embodiments.

### Definitions

In each instance herein, in descriptions, embodiments, and examples, the terms ‘comprising’, ‘including’, etc., are to be read expansively, without limitation.

Thus, unless the context clearly requires otherwise, throughout the description and the claims, the words ‘comprise’, ‘comprising’, and the like are to be construed in an inclusive sense as to opposed to an exclusive sense, that is to say in the sense of ‘including but not limited to’.

The directional terms ‘top’, ‘bottom’, ‘upper’, ‘front’, ‘back’, ‘side’, ‘left’, ‘right’, as used herein are defined given the viewpoint of a user engaging with the component.

The term ‘IoT’ means ‘Internet of Things’.

The term ‘estimated CO₂e’ means carbon dioxide equivalent, which is the number of metric tons of CO₂ emissions with the same global warming potential as one metric ton of another greenhouse gas.

As used herein, ‘approximately’ means up to 10% greater or up to 10% lesser than a particular value.

### General

The following description is given with reference to monitoring of water. It should be appreciated, however, that the systems and methods of the present disclosure may also be used for monitoring other liquids.

The following description is given with reference to systems and methods for monitoring water and energy consumption in a domestic situation such as showers and baths. However, it should be appreciated that the systems and methods of the present disclosure may also be used for liquid flow and detection in pipes, hoses, water-containing vessels and the like.

### Sensor Unit

The disclosed systems and components are readily installed and employed to allow water and energy to be monitored in real-time, allowing significant reductions in water and energy usage, and providing substantial assistance with conservation efforts. Notably, the systems and components require no hardwiring and are not required to be plumbed into piping or other plumbing connections. This provides significant convenience and costs savings for the user.

A key component for the water and energy monitoring system is the sensor unit. The sensor unit allows the monitoring of water flow through a water flow fitting, but without affecting the water flow through the fitting. A water flow fitting will be readily accessible to the user, and in most cases (but not all cases) will be proximate to the site where water exit occurs (i.e., a water egress fitting). In various aspects, the sensor units of this disclosure may be used to monitor water run time for one or more of: bathroom sinks, kitchen, sinks, baths, water tanks, and showers. For example, sensor units can be placed on to water flow fittings such as: spouts, fillers, and taps (e.g., kitchen or bathroom spouts, fillers, and taps), and necks, arms, heads, and roses (e.g., shower necks, arms, heads, and roses). Also included are water pipes and water tanks. In one particular aspect, a sensor unit is placed onto a shower neck, shower arm, shower head, or shower rose, and is used to measure water and energy usage in the shower.

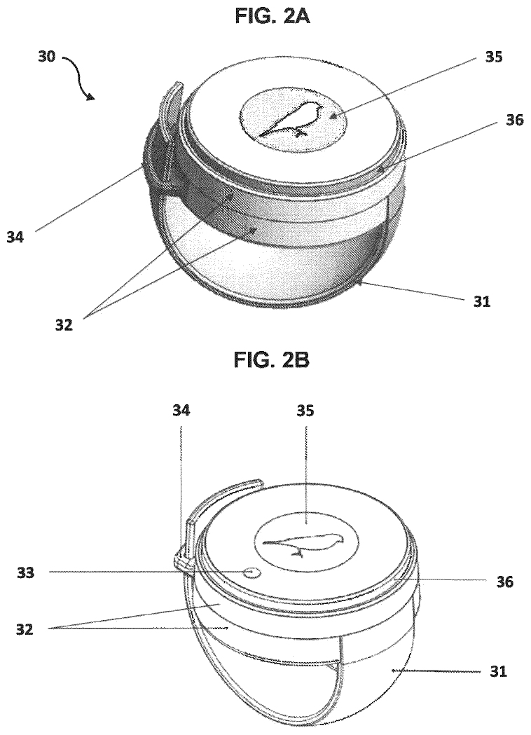

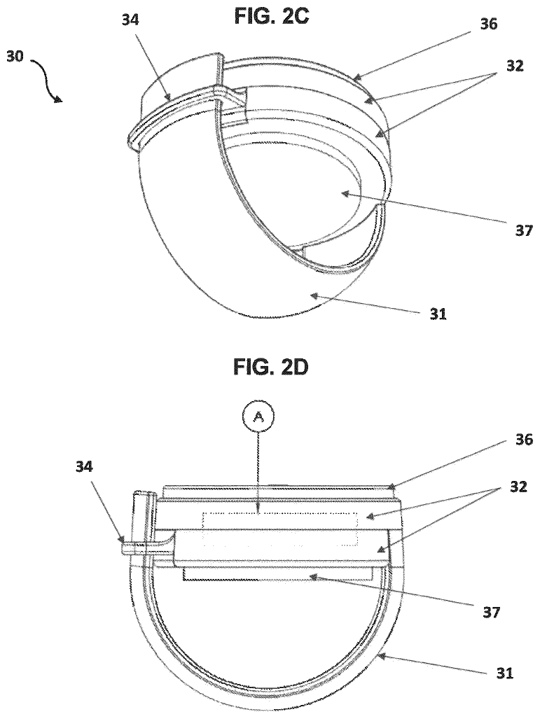

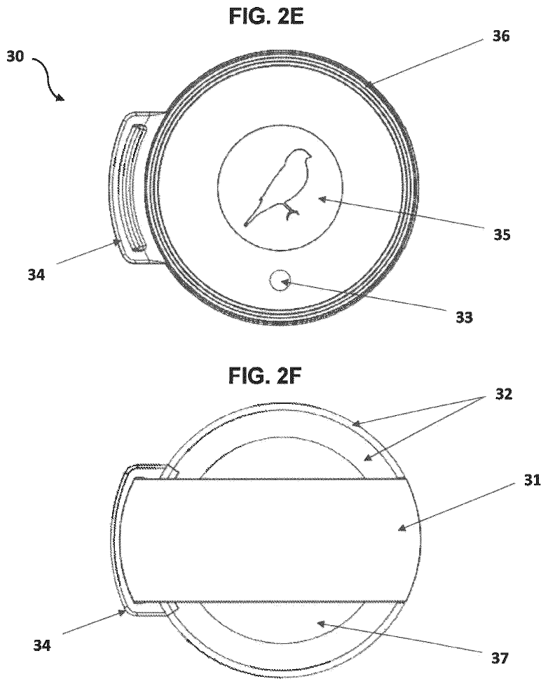

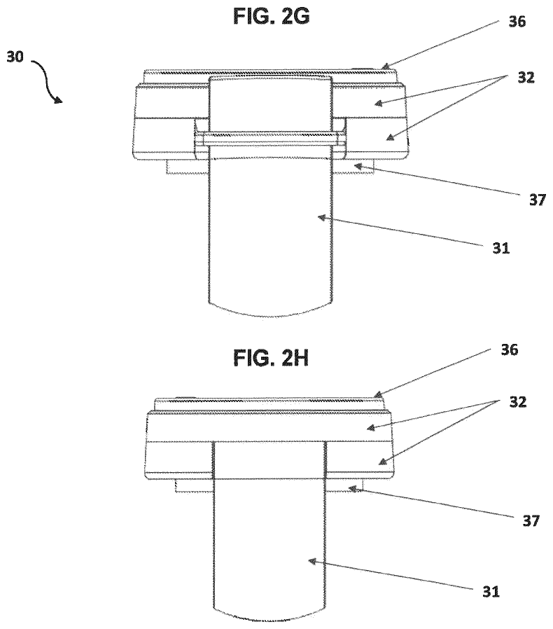

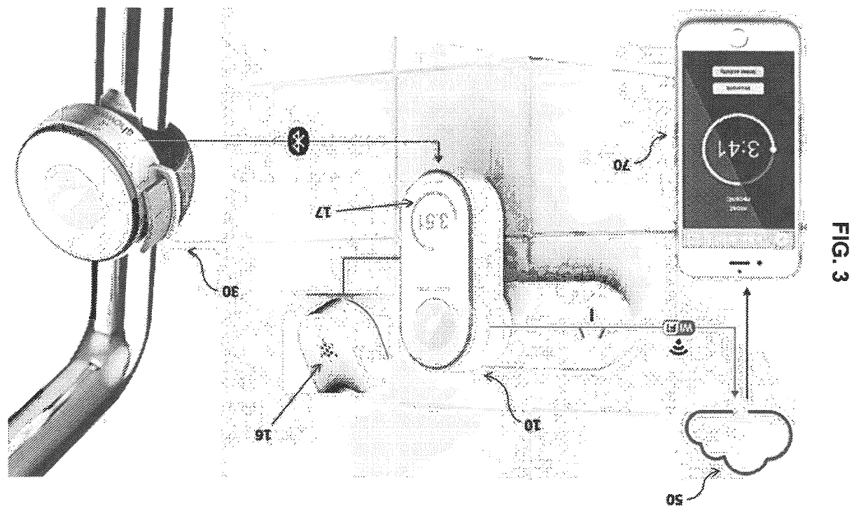

The sensor unit includes a housing. The sensor unit housing comprises a front portion, which includes a front face, and a back portion, which includes a back face. The front face of the housing may include one or more screens or indicator windows (e.g., windows for LED lighting). Optionally, the front face includes branding information or designs. The back face of the housing can include a back plate. The back face can include a surface for contacting a water flow fitting (e.g., anti-slip or pro-grip surface). It is advantageous for the sensor unit housing to be designed so as to prevent or impede entry of water into the interior of the housing. Water proof or water-resistant housing will be particularly useful. For example, the sensor unit housing may be designed similar to a watch. In particular, the housing may include a rim (e.g., bezel) sealing the front portion of the housing to a back portion of the housing. See, e.g., FIGS. 2A-2B. In various aspects, the sensor unit housing may be fabricated from one or more natural and/or one or more synthetic materials. For example, one or more plastics, rubbers, or metals may be used. This includes, in particular, thermoplastics, recyclable plastics, biodegradable plastics, natural rubbers, synthetic rubbers, aluminium, aluminium alloys, and metal matrix composites. Exemplary plastics include but are not limited to polyethylenes, polypropylenes, polyvinyls, and polycarbonates. The rim may comprise one or more elastomers, including thermoplastic elastomers, silicones, rubbers, and the like.

Positioned within the sensor unit housing is a node of electronic, transmitting, and sensing devices. The devices in the sensor unit housing can allow, for example: detecting the turning on and turning off of water; indicating when the water is turned on and off; transmitting the detection data to the hub unit; and powering of the sensor unit. The sensor unit housing will specifically include an accelerometer or a gyroscope. An accelerometer is an electronic sensor that is typically used to measure the acceleration forces acting on an object, in order to determine the object's position in space and monitor the object's movement. A gyroscope is an electronic sensor that is typically used to measure the angular velocity of an object, in order to determine the object's position in space and monitor the object's movement.

In one exemplification, the sensor unit comprises an accelerometer to detect the vibration of the water flowing, and to thereby determine when the water usage starts and stops. For the accelerometer, a vibration threshold can be set. This can be used to determine when water is flowing. The raw data generated from these measurements can then be converted into cost using perimeters set from average power unit cost and gas litre cost. Where both an accelerometer and a gyroscope are used, signals from the gyroscope and the accelerometer are combined with processing algorithm to determine flow or otherwise.

Optionally, a temperature sensor can be used to detect an increase in temperature at the sensor position, and this data can be used to calculate water usage and energy usage, in conjunction with the accelerometer.

In particular aspects, the sensor unit housing holds: an accelerometer, gyroscope or other vibration detector, a battery (e.g., 3 volt battery) or other power source, an on/off indicator (e.g., LED light), a Bluetooth module (e.g., Bluetooth low energy device) or other wireless transmitter, and a microprocessor or microcontroller (e.g., as part of a printed circuit board (PCB)). Included amongst these may be a temperature sensor. Other optional features include an ambient light sensor, pressure sensor, motion sensor, and magnetometer. In this aspect of the disclosure, the gyroscope may also be used to accumulate supplementary vibration data. As an exemplification, the on/off indicator can show (e.g., turn on) when the water is on and the accelerometer is measuring vibrating, and can indicate (e.g., turn off) when the water is off and the accelerometer is no longer measuring vibration. In particular embodiments, the microcontroller within the housing may be setup to provide information such as water utilisation data after a set number of readings, and the period of time of water use.

Certain events may be indicated with an alert and may include, for example: utilisation exceeding a set threshold, unexpected usage, or a low battery condition. The sensor unit includes one or more cinch. The one or more cinch is used for keeping the sensor unit in place. The sensor unit is able to work by being in contact with the water flow fitting. Contact (direct or indirect) ensures that the sensor unit can detect the water flow (e.g., via vibration) through the fitting. One end of a cinch is connected to one side of the housing. The other end of a cinch is free but is able to be associated with the other side of the housing via a cinch holder. In this way, a cinch can be placed around a fitting (e.g., following the arc or circumference of the fitting). Then, once the cinch is placed around the fitting, the free end of the cinch can be associated with a cinch holder. The cinch is thereby adjustable and securable, and this ensures that the sensor unit can be kept in place on the fitting. It will be understood that cinching can be performed by a range of component parts including various straps, belts, bands, cables, ties, ropes, chains, etc. The one or more cinch may be fabricated from one or more natural or synthetic materials. For example, one or more plastics, rubbers, or fabrics may be used. The one or more cinch may comprise one or more elastomers, including thermoplastic elastomers, silicones, rubbers, and the like.

As noted, the cinch is able to be adjusted and secured at the adjusted setting. This will ensure that the sensor unit can be kept in place on various types of fittings and may also include a fastening system to make it difficult for a child to remove. In particular, it will be expected that a cinch can be loosened or tightened as needed for any particular fitting, and then held at this position. The cinch can be held in place, for example, using indexing adjustment ribs or similar protrusions on the underside of the cinch. These can provide improved attachment/securement to various water flow fittings (e.g., shower head or water pipe). The one or more cinch can be held by one or more cinch holders, including, for example, corresponding loops, clamps, hooks, protrusions, etc. In particular, a cinch holder can be designed as a loop to embrace and secure a cinch. The one or more cinch can thereby be pulled through the one or more cinch holder. See, e.g., FIGS. 2C-2D. As other examples, the free end of a cinch may have a plurality of openings, e.g., a row of openings similar to a watch band. These openings may be sized to fit over one or more hooks or protrusions that may be positioned on the side of the housing. When an opening is placed onto the hook or protrusion, this holds the cinch in position. In this way and others, the cinch may be adjusted and secured as desired.

### Hub Unit

A further key component of the water and energy monitoring system is the hub unit. The hub unit receives the water monitoring information obtained by the sensor unit (e.g., water usage duration). In turn, the hub unit transmits this information to data collection means (e.g., one or more cloud or other computing solutions), and the information can then be transmitted to a user device (e.g., personal computer, smart phone, or tablet).

The hub unit includes a housing. The hub unit housing comprises a front portion, which includes a front face, and a back portion, which includes a back face. The front face of the housing may include one or more screens (e.g., display or touch screens). The front face may include one or more indicator windows (e.g., windows for LED lighting). The back or front face of the housing may include one or more openings for audio transmission (e.g., one or more speaker holes). Ideally, the hub unit is positioned such that the display can be viewed by the user during water usage. It is also useful for the hub unit to be positioned with the back face in proximity to a wall; this allows amplification of the audio transmission.

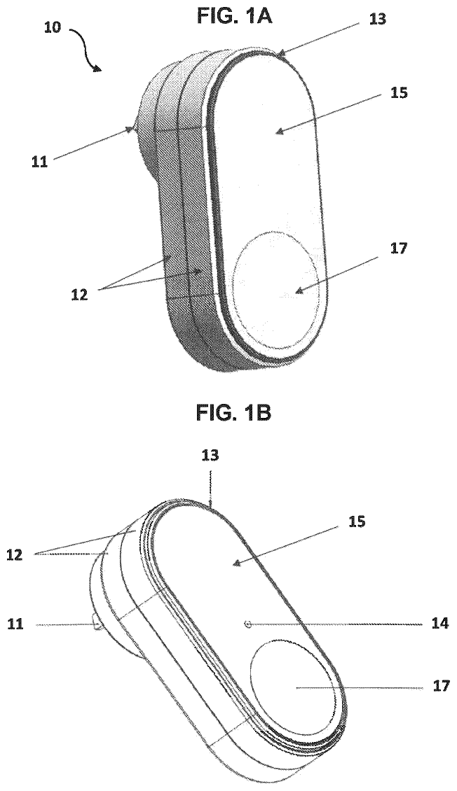

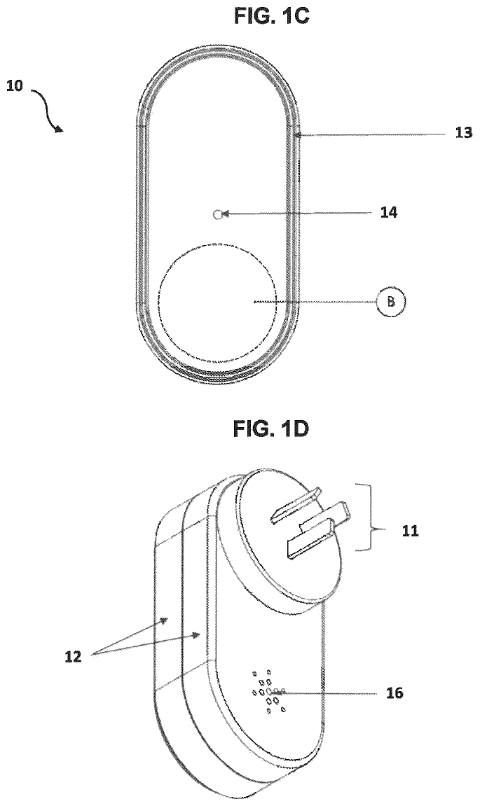

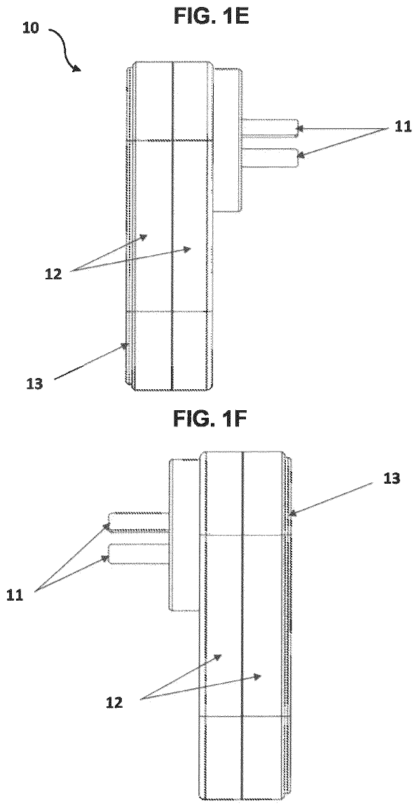

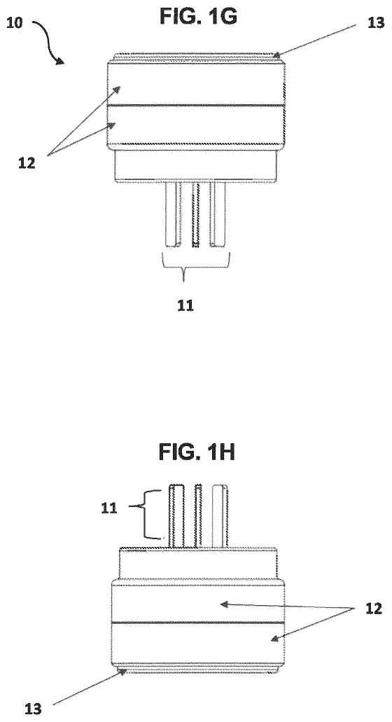

In one particular aspect, the hub unit may be powered by an electrical outlet. For example, the back portion of the housing may include electrical contacts to provide power to the hub unit. The electrical contacts may be included as part of an electrical plug. The electrical plug may or may not be grounded. In various aspects, the electrical plug may be designed to be used in a particular jurisdiction (e.g., European-type plug, US-type plug, Australian-type plug, or New Zealand-type plug) and with a particular voltage (e.g., 110 volts, 220 volts, 230 volts, or 240 volts). See, e.g., FIG. 1D. In other aspects, the hub unit may be powered by a battery power arrangement (rechargeable or not rechargeable), or by a solar power arrangement, or by a combination thereof. The hub unit may be wall mounted. As one exemplification, the hub unit may be provided with a rechargeable battery and with a docking station for charging (e.g., a docking creche, similar to that used for a mobile phone). In another exemplification, the hub unit may be powered by electrical engagement with an electrical socket.

As with the housing for the sensor unit, it will be advantageous for the hub unit housing to be designed so as to prevent or impede entry of water into the interior of the housing. Water resistant housing will be particularly useful. For example, the hub unit housing may be designed similar to a watch. In particular, the housing can include a rim (e.g., bezel) sealing the front portion of the housing to a back portion of the housing. See, e.g., FIGS. 1A-1B. The hub unit housing may be fabricated from one or more natural and/or one or more synthetic materials. For example, one or more plastics, rubbers, or metals may be used. This includes, in particular, thermoplastics, recyclable plastics, biodegradable plastics, natural rubbers, synthetic rubbers, aluminium, aluminium alloys, and metal matrix composites. Exemplary plastics include but are not limited to polyethylenes, polypropylenes, polyvinyls, and polycarbonates. The rim may comprise one or more elastomers, including thermoplastic elastomers, silicones, rubbers, and the like.

Positioned within the hub unit housing is a node of electronic, receiving, and transmitting devices. These devices can make it possible, for example: to receive information from the sensor unit; to transmit information to a data storage arrangement (e.g., cloud or other computing arrangement); to time the water flow (i.e., measuring active period of accelerometer and/or gyroscope); to indicate when the hub unit is turned on and off; and to power the hub unit. In particular aspects, the hub unit housing holds: a power transformer (e.g., 240 volt to 5 volt), a display mechanism (e.g., digital display such as OLED, LED or LCD), a speaker or other audio device, an on/off indicator (e.g., LED light or vibrator), a receiver for wireless transmission (e.g., Bluetooth module such as Bluetooth low energy device), a wireless transmitter (e.g., WiFi chip, micro-sim card 4G, IoT or), and a microprocessor or microcontroller (e.g., as part of a printed circuit board (PCB)). The hub unit may also include a humidity sensor.

In specific aspects, where the hub unit is used with a docking station, the hub unit can include at least one port for interacting with the docking station. The at least one port can be included on the bottom of the hub unit. The hub unit can further include a rechargeable battery, e.g., rechargeable lithium battery, which is charged via interaction with the docking station. The docking station for the hub unit can include a housing to encompass one or more electronics. The housing may be fabricated from one or more natural and/or one or more synthetic materials, as described in detail herein. Exemplary materials include but are not limited to polyethylenes, polypropylenes, polyvinyls, and polycarbonates. The housing for the docking station may have a rim, e.g., a bevel, for sealing the front portion of the housing to a back portion of the housing. The housing may further include a base to sit the docking station on a surface. The rim (and the base) of the docking station may comprise as exemplary materials one or more elastomers, including thermoplastic elastomers, silicones, rubbers, and the like.

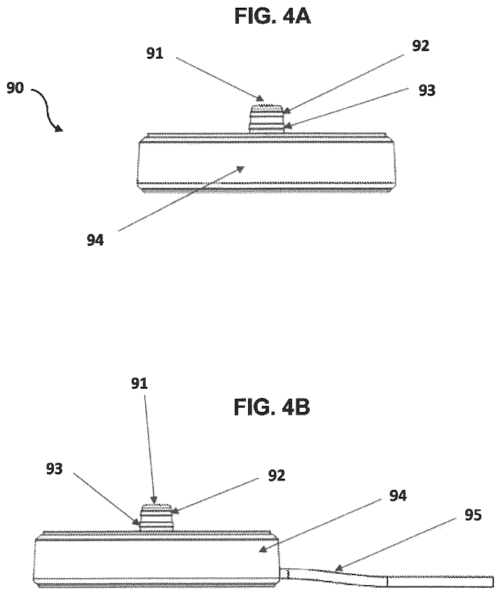

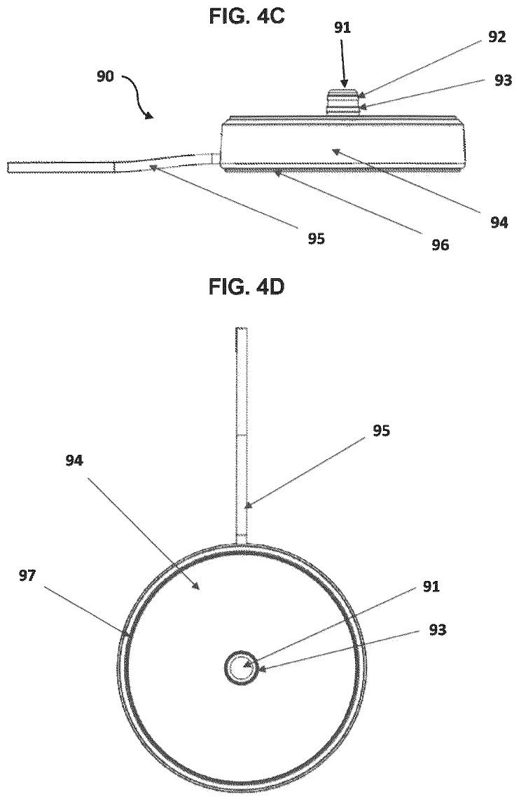

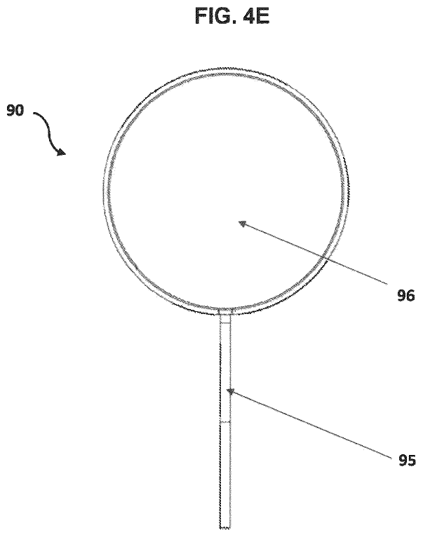

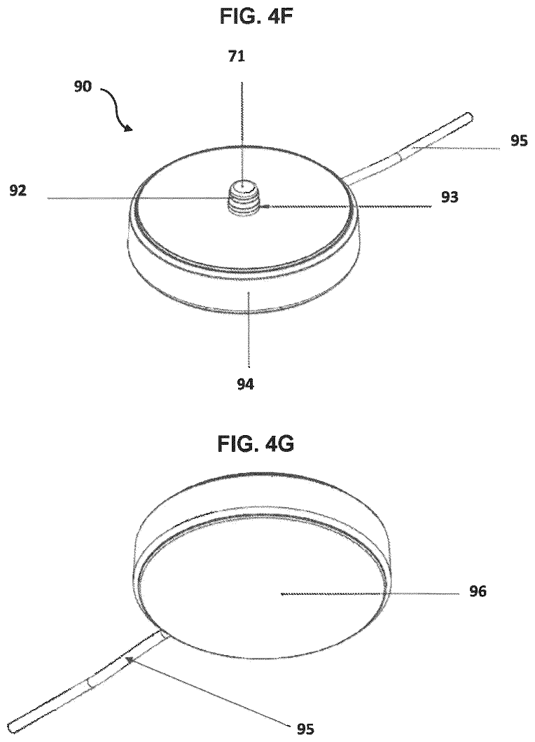

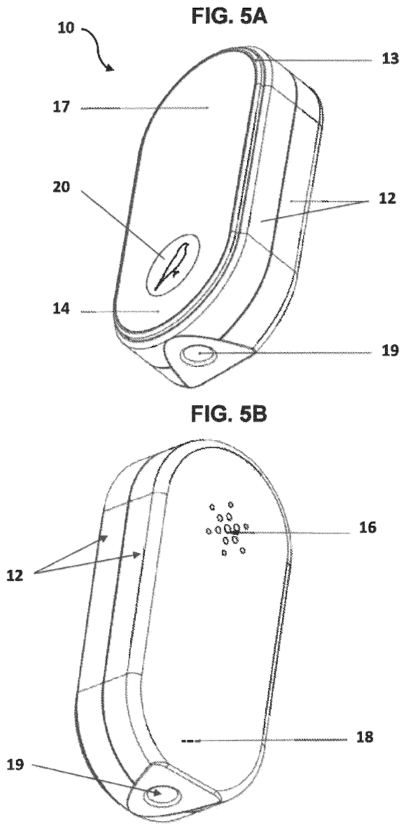

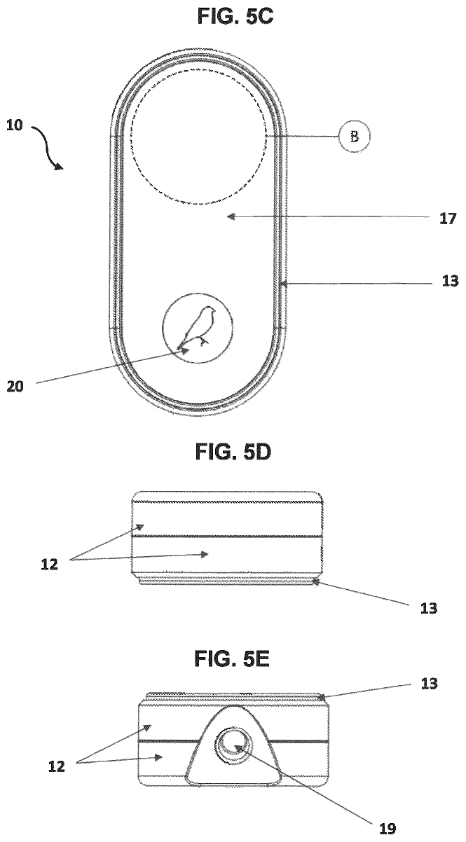

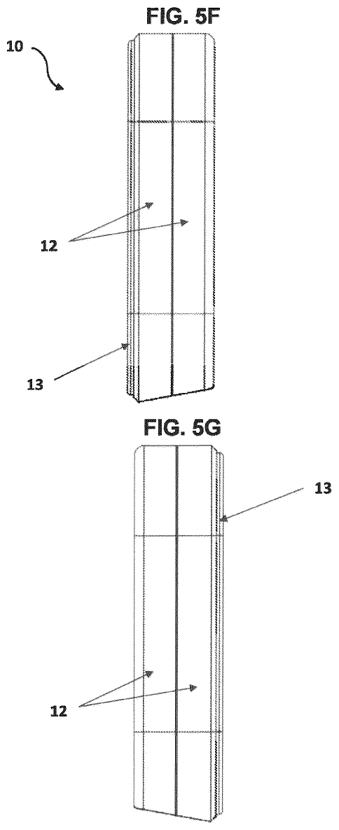

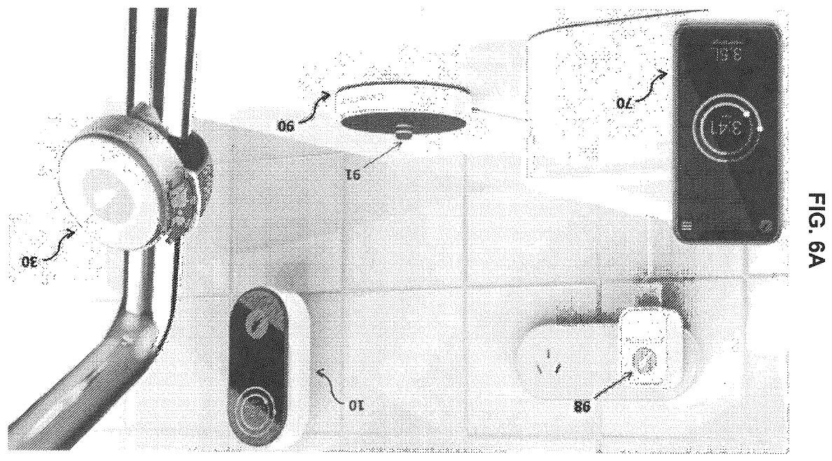

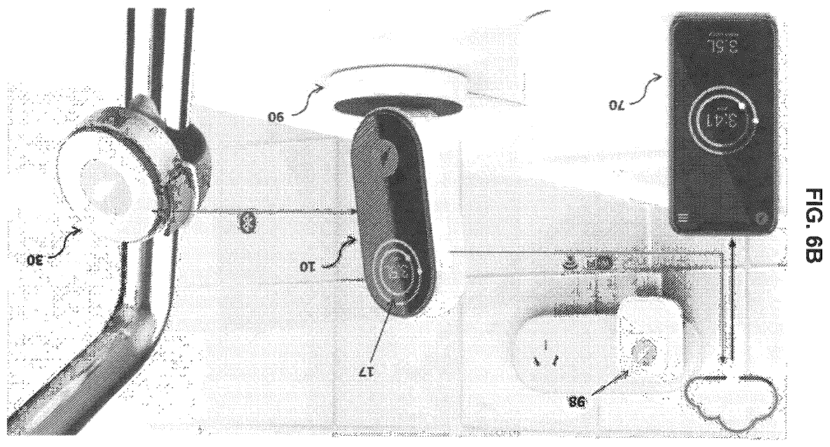

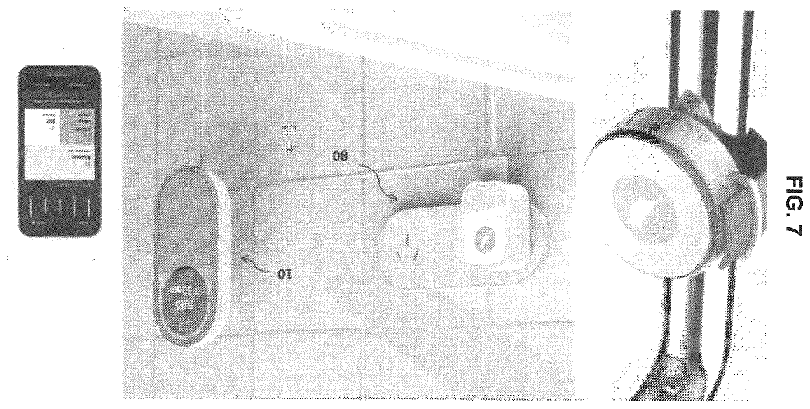

To allow charging of the hub unit, the docking station can include a connector that allows engagement with the hub unit. The connector may be designed as one or more projections. For example, the connector may comprise one or more spigots, or one or more prongs, or one or more teeth, or one or more pins, or one or more plugs, etc. The one or more projections of the docking station will allow interaction with the one or more ports of the hub unit, and thereby provide power to the hub unit battery. For example, the connector for the docking station may be a magnetic locating spigot. In addition, the connector of the docking station will be expected to include one or more contacts for interaction with the chargeable battery arrangement of the hub unit. Inclusion of two contacts may be particularly useful. In certain aspects, the docking station may be powered by a charger. For example, charge cable (e.g., 3 mm charge cable) may run between the docking station and a charger (e.g., 240 volt/5 volt charger). The charger, in turn, may be plugged into an electrical outlet. See, e.g., FIGS. 4F-4G. See, also as examples, FIGS. 5A-5B and FIG. 6. Wireless charging of the docking station may also be utilised.

As an exemplification, a display on the hub unit can show how long the user has been using the water (e.g., length of time in the shower). The audio device can provide a voice prompt that will tell the user how many minutes they have been using the water (e.g., how many minutes in the shower, the amount of water used, and the water costs). Voice prompting may carry on during the water usage, for example, at one minute intervals. In addition or in lieu of this, voice prompting may only occur at the end of water usage. It is also possible to include an audio alert (e.g., voice prompt or warning sound) to indicate when the recommended water use time is exceeded. Prompts can be readily adapted for different age groups (e.g., small children, teens, etc), genders, or preferences. The hub can also send wireless alerts to an electronic device, for example, a computing device such as a smart phone, tablet, or PC, to advise if preset shower time has been exceeded.

Notably, the hub unit receives and utilises the water use data from the sensor unit, and the hub unit also transmits this data to a computing platform. For example, the hub unit can display a timer and water usage data, which is streamed live from the sensor unit (e.g., via Bluetooth). The hub unit can also log the data through a computing platform (e.g., via WiFi or IoT), making it easily accessible to an electronic device (e.g., computing device). The computing platform may be a data storage arrangement, such as a cloud, or a website. In one aspect, data from the data storage arrangement (e.g., cloud) can then be transmitted wirelessly to an electronic device, for example, a computing device. This includes, for example, a PC or a smart device, such as a tablet, smart phone, smart watch, smart glasses, etc. The electronic device will have an appropriate program or application software (app) for displaying and analysing this data. Alternatively, the data can be transferred to a website using the IP or DHCP protocols whereby the data can be monitored remotely over the internet using a software program designed to display and analyse the data. It will be understood that any program or app can provide various information on water and energy usage, for example, usage readings per day, per week, per month, per year, etc. Specifically provided may be a list of shower times, dates, and length of time in the shower. The information provided will include how much water has been used, and how much water has been saved. Water and energy use targets and assessment can be keyed to certain users. For example, the set up and display can be different for different age groups (e.g., small children, teens, etc).

In one aspect, the system may be customised to include the user's energy and water costs along with showered flow rate.

### Systems

A water and energy monitoring system of the present disclosure includes a sensor unit being in wireless communication with a hub unit, and the hub unit being in wireless or IoT communication with a data storage arrangement. In this way, the sensor unit transmits the water usage data to the hub unit, and the hub unit transmits the water usage data to the data storage arrangement, and the data can be accessed by the user. This can be transformed to include energy and water costs and savings.

While wired communication can also be used, it will be understood that wireless communication means are preferred. Transmission can be to a corresponding receiver or other endpoint. Wireless transmission includes, for example, transmission by radio-frequency technology, optical technology, and other wireless technology. Wireless application protocols are specifically noted, such as Bluetooth, Bluetooth LE, BLE, ZigBee, NFC, WiFi, WiFkah (HaLow), LF Z-Wave, 6LoWPAN, LoRaWAN, LTE, NB-IoT, RFID, Thread, Weightless, 2G, 3G/4G, and 5G. Examples of Bluetooth modules (e.g., 2.4 GHz band as WiFi) that can be added are the RN-41 Bluetooth modules, the KC-41, KC 11.4, KC-5100, KC-216 or KC-225 data serial modules, and/or the BT-21 module as well as IoT RFID, IEEE 802.15.4, 6LoWPAN, WiFi, LiFi, EnOcean, DigiMesh, ANT & ANT+, Weightless-N+P+W, SigFox, RFID, NFC, 5G, NB-IoT, LTE-M1, LTE Cat 0, 1, & 3, WiFi-ah (HaLow), Thread, and Z-Wave. Examples of wireless protocols that can be utilised include, but are not limited to, the IEEE 802.11a, IEEE 802.11b, IEEE 802.11g and IEEE 802.11n modulation. Other examples include ZigBee, Z-wave and IEE 802.15.4 modulation. In particular aspects, the sensor unit transmits to the hub unit via Bluetooth technology, while the hub unit transmits to the data storage arrangement via WiFi or IoT technology. It will be understood that numerous wireless technologies have been developed and are readily employed, and that the present disclosure is not limited to use with any particular type of wireless transmission.

In a particular aspect, the data storage arrangement is a cloud (e.g., a cloud-based server); however, other data storage arrangement may be utilised, for example, one or more website databases. As an exemplification, signals created by water flowing through the water flow fitting (e.g., shower head or water pipe) are detected by the sensor unit, and transmitted to the hub unit via Bluetooth, IoT or other wireless signal. The transmitted data is then received by the hub unit, processed by a microcontroller or microprocessor in the hub unit, which functions as a data bridge. Using WiFi or other wireless signals, e.g., IoT, 5G, 4G, the hub can upload the data to remote data storage, e.g., cloud storage or website. Programming or software application converts to raw data from the accelerometer and or the gyroscope into run time and estimated water and energy usage. This is determined using parameters during initial setup and calibration. The program or software application may interact directly with the sensor unit to receive the data via download from the remote data storage (e.g., cloud storage). The data may then be accessed by the user, for example, with an electronic device (e.g., computing device).

The utilisation of a wireless signals such as Bluetooth provides numerous advantages over other modes of signal transmission such as cellular transmission, including the elimination of fees that may be associated with cellular phone usage, greatly reduced power consumption relative to cellular signals and transmission, and the ability to use the apparatuses and systems in locations that are not served by cellular coverage. As noted, any program or software application can be used to provide the user or utility provider with the monitored information on water and energy usage. In certain aspects, application software may be installed on consumer electronic devices, e.g., computing devices, such as smart phones, tablets, or PCs. The program or software used in accordance with this disclosure can thereby provide a data rich platform that allows the user to visualise water and energy consumption data in many different formats. This data may also be gamified to promote better usage.

As exemplifications, the program or software application can be capable of presenting water and energy utilisation in a variety of visually useful formats, in real time, including charts of various types with variable data criteria. Exemplary data depiction includes, e.g., dashboard screens showing today's water and energy utilisation as a percentage of average daily use, water status, and month-to-date usage of water and energy against the monthly water and energy budget. Also included are historical screens, e.g., water usage broken down by the hour, day, week, month and year. Comparisons to similar households can be shown and additional period information, including maximum and minimum usage numbers and dates. Also included are the recording of water and energy usage events, e.g., scheduled recordings for certain days/times. Also included are special notifications, e.g., for when usage exceeds a threshold value that the user has set, the user will be notified. For example, the program or application software can advise when water use times exceed a pre-set limit (e.g., a child has spent too long in the shower) and send an alert.

In a specific aspect, a basic installation process can be used when setting up the disclosed systems. For example, with the software application installed on a PC and/or smart device, a registration process can be used to creates a user account associated with the serial numbers of the system components. In particular, the QR or analogous optically read codes and the codes can be scanned. The hub unit can then be powered on to pair with the sensor unit and prompt for any associated password if required. The sensor unit can be placed onto the water flow fitting (e.g., shower head or water pipe). The water flow can then be turned on for sensor unit set up. As an exemplification, the hub unit can be positioned within 1-2 meters of the sensor unit. Optimal locations for the hub unit includes those in which the hub unit is visible for the person that is using the water source. In addition, the hub unit may be optimally located at a power source, e.g., at an electrical outlet. A suitable location for placement of the hub unit relative to sensor unit may be determined by moving the hub unit while observing a visible signal (e.g., LED light) that is activated when the sensor unit and hub unit are in communication with each other.

The systems of the present disclosure may be adapted to include one or more visual alarms and/or one or more auditory alarms. In particular, one or more alarm or similar signals can be incorporated for the sensor unit or hub unit, or both units. Alarms and similar signals can also be transmitted by the hub unit to the user's electronic device (e.g., computing device). For example, pre-set alarms or programmed alarms can be used, as well as changes to one or more of screen displays or auditable alarm. This can include, for example, blinking of a displayed number or blinking of backlighting, and/or changing colours of a displayed number or changing colours of backlighting (e.g. green to yellow to red or auditable alarm). As specific exemplifications, one or more displays can exhibit a first background or text colour (e.g., green) when a first volume of water has been utilised. After a second volume of water use has been utilised, the one or more displays can exhibit a second background or text colour (e.g., yellow). After a third or further volume of water has been utilised, the one or more displays can exhibit a third background or text colour (e.g., red). A pre-set alarm might include a visual reference, for example, an inoperative condition such as an inactive sensor unit, low power source, and/or other default limits. Programmed visual or auditory alarms would allow for individual selection (e.g. volume over set point, flow rate set point, total volume exceeded set points) which may be restricted by the default settings.

In use with the disclosed systems are various electronic devices such as smart phones, tablets, PCs, and other computing devices, which can be located remotely from the hub unit. The sensor unit and hub unit can each include a microcontroller or microprocessor with communication and control lines that communicate wirelessly. Hence, communication and control lines can be used to transfer data pertaining to water use and other water parameters from the sensor unit to the hub unit, and the hub unit can in turn, use communication and control lines to transfer data to an electronic device, for example, a computing device such as a smart phone, table, PC, or similar apparatus. It is also possible to use wireless routers to support private point-to-point or bridging operations which could be used to transfer water parameter data. Other kinds of transmission protocols can be utilised, e.g., ISM (industrial, scientific and medical) bands. In certain aspects, the hub unit will communicate with the electronic device at a specifically determined timing frequency. Accordingly, the update frequency can be programmed for various time periods, e.g. minute intervals, ten or fifteen minute intervals, hourly intervals, daily intervals, weekly intervals, monthly intervals, and yearly intervals. In addition, the data can be processed by an automated arrangement and reports can be created every hour, every day, every week, and every month. The hub unit can be programmed to communicate at certain time frequencies, such as every second, every 5 seconds, every 10 seconds, every 30 seconds, or every minute.

### Methodology

The components described herein can be used to monitor water usage or to monitor water and energy usage. Given current water shortages and energy shortages, and CO₂ reduction targets, the disclosed components and methods benefit the consumer and communities as a whole.

Accordingly, a method of monitoring water usage is described, the method comprising: actuating water flow through a water flow fitting and actuating a sensor unit to detect the water flow, wherein the sensor unit is positioned on the water flow fitting, and wherein the sensor unit comprises an accelerometer and/or gyroscope that detects the vibration of water flow in the water flow fitting, thereby monitoring the water usage. In accordance with this method, the sensor unit can be used transmit the water use data to a hub unit. The hub unit can, in turn, transmit the water use data to a data storage arrangement. The data storage arrangement can be accessed by an electronic device, for example, a computing device. The electronic device can provide a user interface (e.g., program or software application) for communicating the water use data.

In addition, a method of monitoring water usage and energy usage is described, the method comprising:
actuating heated water flow through a water flow fitting and actuating a sensor unit to detect the heated water flow, wherein the sensor unit is positioned on the water flow fitting, and wherein the sensor unit comprises an accelerometer and/or gyroscope) that detects the vibration of the heated water flow in the water flow fitting, thereby monitoring the water usage and the energy usage.

In accordance with this method, the sensor unit can be used transmit the water use data to a hub unit. The hub unit can, in turn, transmit the water use data to a data storage arrangement. The data storage arrangement can be accessed by an electronic device, for example, a computing device. The electronic device can provide a user interface (e.g., program or software application) for communicating the water use data. At the same time, it is possible to convert to energy use and cost and communicate this to the user. In addition, the program or software application can include settings that can be modified/personalised for more accurate costings and usage, i.e., water flow rates, energy costs, water costs, etc.

The hub unit can be pre-programmed for exemplary water flow rates (e.g., 9, 12, or 215 litres per minute, or any value therebetween), exemplary water temperatures (e.g., between about 35 and 45° C.), and/or exemplary water heating levels (e.g., 15° C., 16° C., 17° C., 18° C., above room temperature or any value therebetween) for the water and energy usage calculations. Alternatively, the user can enter this information, e.g., via the user interface. For example, the user can enter the measured flow rates (e.g., as determined by the filling of a bucket or other container in a given time period) and/or the measured temperatures or temperature differences (e.g., as determined by a thermometer or water heating system) for the water that is being used. However, with the disclosed methods, it is not necessary to have user input or flow or temperature calibrations. Rather, a database (e.g., in a cloud server) may include the information for water flow rates and water temperatures with which the present methods may be utilised.

It will be understood that, from water flow rates and water temperatures, it is possible to calculate the energy usage associated with the water usage. For example, the disclosed methods can employ the formula:

$$E = C \times V \times ( Δ T / PR )$$

where:
E=energy in kWh
C=specific heat of water—4.187 kJ/kgK, or 1,163 Wh/kg° C.
V=volume of water to heat
ΔT=Th−Tc
Th=temperature of hot water
Tc=temperature of input cold water
PR=performance ratio (it includes losses of heat through fittings, pipes, and tanks), default value=0.9

Similarly, an energy calculator can be used. The calculator uses the following data:
V (volume in l/minute): ______ litre/minute
Temperature of hot water Th (in ° C.): ______° C.
Temperature of cold water Tc (in ° C.): ______° C.
PR: 0.9

With the above data (V, Th, Tc, and PR), it is possible to calculate:
ΔT (in ° C.): ______° C.
E (Energy in kWh): ______ kWh
Currency: ______ (e.g., € or $)
Cost of energy: ______ € or $/kWh or gas conversion
Total for energy bill per minute: ______ (e.g., € or $)
Total for energy bill per month: ______ (e.g., € or $)
Total for energy bill per month: ______ (e.g., € or $)

Other specific parameters include:
Number of water usage events (e.g., number of showers)
Length of water usage times and average times (e.g., length of shower and average length of shower)
Water and energy costs more than pre-set value
Savings in water and energy costs per week/month/year

Calculations can also be adapted for gas heated hot water. It is thereby possible to obtain water and energy usage calculations for the levels and costs incurred per day, per week, per month, per year, etc. The calculations can determine how much water and/or energy has been used over any given period, and how much water and/or energy has been saved over any given period. While a certain accuracy will be desired for these calculations, it will be understood that important considerations for the disclosed methods are behavioural changes. Therefore, rather than looking to precise monetary or kilowatt calculations, the disclosed methodology looks to inspire and maintain improved behaviours towards water and energy conservation. It will be understood that water usage and/or water costs can be monitored with or without the accompanied monitoring of energy usage and/or energy costs.

Notably, the components, systems, and methods of this disclosure provide numerous advantages. The sensor and hub units require no plumbed connection to the water flow. The accelerometer and/or gyroscope included with the sensor unit detects the flow of water and hence negates the need for any mechanical interference with the water flow. This avoids any plumbing installation and avoids the costs and inconveniences associated therewith. The sensor unit cinches around the water flow fitting (e.g., shower head or water pipe) allowing quick and easy installation without tools. The sensor unit communicates with the hub unit to advise when the water flow is turned on/off and has ultra-low power usage. This means that its battery life can be at least 5 years. Thus, the system can be kept on and does not require to be turned on/off by the user. Multiple sensor units and hub units can be used in the same household. This allows the user to better understand and control water/energy usage. The programming and application software can be adapted to give more accurate measurement of energy and water use for the user. For example, different shower head flow rates, different electric/gas costs kWh, etc, can be taken into account. The programming and application software can be used to monitor water/energy usage for each day/month/year and to show savings in litre/kWh/dollar or gal/kWh/dollar terms.

### Use in Water Flow and Detection

It is often very difficult to determine where a leak in a water system is originating from. The present disclosure includes a system of one or more sensors that can be used on a water pipe, hose or tank to identify the location of a leak.

In one aspect, several sensors may be placed on a water pipe. Water flow to the pipe may be halted and any water flow is measured, and data sent to the central hub. Flow as water detected will indicate that the pipe is leaking.

The location of the leak can be determined by moving the sensors up- and/or downstream along the pipe and detecting water flow or an absence of water flow at various points along the length of the pipe.

In the case of a water-containing vessel such as a water tank, a sensor may be located on the tank and any water flow fittings closed off. Detection of water flow indicates that the tank is leaking.

Signals from the gyroscope and the accelerometer are combined with a processing algorithm to determine flow or otherwise. In this aspect of the disclosure, the gyroscope signal is the most important in detecting water flow.

Where both an accelerometer and a gyroscope are used, signals from the gyroscope and the accelerometer are combined with processing algorithm to determine flow or otherwise.

### Exemplifications

Aspects of the components and systems of this disclosure will now be described with reference to the accompanying drawings. The drawings and description thereof are provided for the purpose of illustrating specific embodiments and are not intended to limit the invention in any way.

In FIGS. 1A-1H, an exemplification of the hub unit (10) is depicted. The hub unit housing (12) is shown, along with the rim for the housing (13; depicted as a bevel). The electrical contacts (11) provide power to the hub unit. The node (B) provides for electrical and other functional activity for the hub unit. In this example, the node includes at least a digital display mechanism, a speaker, an on/off indicator (LED light), a Bluetooth receiver module, IoT, a WiFi chip, a battery (e.g., rechargeable battery), and a PCB. Also shown in this exemplification is the display screen (17), which displays the water usage data (e.g., time in shower), the status indicator (14; shown here as LED lighting), which indicates on/off status for the hub unit, and the plurality of openings for audio transmission (16), which allow the hub unit to communicate voice or sound prompts/alarms. The optional area for branding (15), e.g., trademarks, tradenames, or logos is also shown.

In FIGS. 2A-2H, an exemplification of the sensor unit (30) is depicted. The sensor unit housing (32) is shown, along with the rim for the housing (36; depicted as a bevel), and the back plate (37). The node (A) provides for power and other functional activity for the hub unit. In this embodiment, the node includes at least an accelerometer and/or a gyroscope, a battery, an on/off indicator (LED light), a Bluetooth transmitter, and a PCB. Also shown in this exemplification is the optional branding area (35), which displays the relevant tradename, trademark, or logo, the status indicator (33; shown here as LED lighting) which indicates on/off status for the sensor unit, the cinch (31) (length adjustable), which allows the sensor unit to be strapped to the water flow fitting, and the cinch holder (34; shown here as a loop), which allows the cinch to be adjusted and secured at a particular length/setting.

In FIG. 3, an exemplification of the system is depicted. The sensor unit (30) is shown as being strapped to a shower arm in this embodiment. The sensor unit (30) uses Bluetooth to communicate this water usage information (here being water flow through the shower arm) to the hub unit (10). The hub unit (10) displays the water usage information (here shown as time in shower) on the display (17), and provides audio prompts regarding the water usage information via audio openings (16). The hub unit (10) also uses WiFi to communicate the water usage information to a cloud server (50). The cloud server (50) provides the water usage information to a smart phone (70), which has application software to calculate water/energy costs and to display usage and cost information for the user, e.g., as charts, graphs, lists, etc.

In FIGS. 4A-4G, an exemplification of the docking station (90), which can be used with a hub unit, is depicted. The docking station housing (94) is shown. Also shown is the base (96), rim (97; depicted as a bevel), and the charge cable (95) for the docking station (90). The charge cable (95) connects the docking station (90) to a charger (98) (e.g., 240 volt/5 volt charger; not depicted here). The charger, in turn, is plugged into an electrical outlet (not depicted here). To interact with the hub unit, the docking station includes a connector (91; depicted as a magnetic spigot), which fits into the port of the hub unit. The connector includes a first (92) and second (93) contact point to allow charging of the hub unit battery.

In FIGS. 5A-5G, a further exemplification of the hub unit (10) is depicted. The hub unit port (19) docks with the docking station to provide charging to the hub unit. The hub unit housing (12) is shown, along with the rim for the housing (13; depicted as a bevel). The node (B) provides for electrical and other functional activity for the hub unit. In this example, the node includes at least a digital display mechanism, a speaker, an on/off indicator (LED light), a Bluetooth receiver module, a WiFi chip, a battery (e.g., rechargeable battery), and a PCB. Also shown in this exemplification is the display screen (17), which displays the water usage data (e.g., time in shower), the status indicator (14; depicted as LED lighting), which indicates on/off status for the hub unit, and the plurality of openings for audio transmission (16), which allow the hub unit to communicate voice prompts. An option for a branding area (20) is also shown.

In FIGS. 6A-6B, a further exemplification of the system is depicted. In this exemplification, the hub unit (10) can be charged by docking onto a docking station (90). The sensor unit (30) is shown as being strapped to a shower arm. The sensor unit (30) uses Bluetooth to communicate this water usage information (here being water flow through the shower arm) to the hub unit (10). The hub unit (10) displays the water usage information (here shown as litres of water used in shower) on the display (17). The hub unit (10) also uses WiFi or IoT to communicate the water usage information to a cloud server (50). The cloud server (50) provides the water usage information to a smart phone (70), which has application software to calculate water/energy costs and to display usage and cost information for the user, e.g., as charts, graphs, lists, etc. Further, in this exemplification, the docking station (90) is connected to a charger (98) (e.g., 240 volt/5 volt charger) via a charge cable (95), and the charger (98) is plugged into an electrical outlet. The docking station includes a connector (91; e.g., depicted as a magnetic locating spigot), which fits into the port of the hub unit, and provides charge to the hub unit battery (e.g., rechargeable lithium battery).

In FIG. 7, a further exemplification of the system is depicted. In this exemplification, the hub unit (10) can be charged by engagement with an electrical socket (80). FIG. 7 also shows an alternative exemplification of the hub unit (10), which is more slimline that the hub unit shown in the other drawings.

Persons of ordinary skill can utilise the disclosures and teachings in this specification to produce other embodiments and variations without undue experimentation. All such embodiments and variations are considered to be part of this invention.

Accordingly, one of ordinary skill in the art will readily appreciate from the disclosure that later modifications, substitutions, and/or variations performing substantially the same function or achieving substantially the same result as embodiments described herein may be utilised according to such related embodiments of the present invention. Thus, the invention is intended to encompass, within its scope, the modifications, substitutions, and variations to processes, manufactures, compositions of matter, compounds, means, methods, and/or steps disclosed herein.

For example, while specific materials and fabrications are set out herein, it will be understood that the components and component parts of this disclosure are not limited to any particular material/materials or fabrication/fabrications.

In this specification, where reference has been made to external sources of information, including patent specifications and other documents, this is generally for the purpose of providing a context for discussing the features of the present invention. Unless stated otherwise, reference to such sources of information is not to be construed, in any jurisdiction, as an admission that such sources of information are prior art or form part of the common general knowledge in the art.

The description herein may contain subject matter that falls outside of the scope of the claimed invention. This subject matter is included to aid understanding of the invention.

1. A water and energy monitoring device comprising:
a sensor unit comprising an accelerometer and/or gyroscope and housing adapted to enclose the accelerometer and/or gyroscope,
wherein the sensor unit is adapted to be positioned on a water flow fitting,
wherein the accelerometer and/or gyroscope measures vibrations from the water flow fitting, and
wherein the vibrations from the water flow fitting correlate to water and energy usage by a user.

2. The water and energy monitoring device of claim 1, wherein the sensor unit comprises the gyroscope.

3. The water and energy monitoring device of claim 1, wherein the water flow fitting is selected from the group consisting of: plumbing spouts, plumbing fillers, plumbing taps, plumbing necks, plumbing arms, plumbing heads, plumbing roses, shower necks, shower arms, shower heads, shower roses, shower pipes, water pipes and water tanks.

4. The water and energy monitoring device of of claim 1, wherein the sensor unit further comprises one or more of: a temperature sensor, a power source, an on/off indicator, a wireless transmitter, and a microprocessor or microcontroller and wherein (i) the power source comprises a battery; (ii) the on/off indicator comprises an LED light; (iii) the wireless transmitter comprises a Bluetooth transmitter; and/or (iv) the microprocessor or microcontroller are included in a printed circuit board.

5. (canceled)

6. The water and energy monitoring device of claim 1, wherein the
sensor unit includes a cinch adapted to hold the sensor unit on the water flow fitting and wherein the sensor unit includes a cinch holder adapted to allow adjustment and securement of the cinch.

7. (canceled)

8. The water and energy monitoring device claim 1, wherein the housing of the sensor unit is water resistant or water proof.

9. A water and energy monitoring device comprising:
a sensor unit,
a hub unit comprising a wireless receiver to receive water usage data from a sensor unit, and housing adapted to enclose the wireless receiver,
wherein the sensor unit comprises an accelerometer and/or gyroscope,
wherein the sensor unit is adapted to be positioned on a water flow fitting,
wherein the accelerometer and/or gyroscope measures vibrations from the water flow fitting,
wherein the vibrations from the water flow fitting correlate to water usage by a user,
wherein the sensor unit processes data regarding the water use, and
wherein the sensor unit wirelessly transmits the data to the hub unit.

10. The water and energy monitoring device of claim 9, comprising the gyroscope.

11. The water and energy monitoring device of claim 9, wherein the water flow fitting is selected from the group consisting of: plumbing spouts, plumbing fillers, plumbing taps, plumbing necks, plumbing arms, plumbing heads, plumbing roses, shower necks, shower arms, shower heads, shower roses, shower pipes, water pipes and water tanks.

12. The water and energy monitoring device of claim 9, wherein the hub unit further comprises one or more of: a digital display, a humidity sensor, a power transformer, a speaker or other audio device, an on/off indicator, and a microprocessor or microcontroller and wherein: (i) the transformer is a 240 volt to 5 volt transformer; (ii) the digital display is an OLED, LED, or LCD display; (iii) the on/off indicator is a LED light or vibrator; (iv) the wireless transmission receiver is Bluetooth receiver; (v) the wireless transmitter is a WiFi or 4G transmitter; and/or (vi) the microprocessor or microcontroller are included in a printed circuit board.

13. (canceled)

14. The water and energy monitoring device of claim 9, wherein the housing of the hub unit is water resistant or water proof.

15-25. (canceled)

26. A method for monitoring water and/or energy usage comprising:
measuring vibrations from a water flow fitting, wherein the vibrations are measured by an accelerometer and/or gyroscope enclosed in a sensor unit, wherein the sensor unit is positioned on the water flow fitting, and wherein the vibrations from the water flow fitting correlate to water usage by a user,
with the sensor unit, processing data regarding the water use by the user,
transmitting the data wirelessly from the sensor unit to a hub unit, the hub unit comprising a wireless receiver to receive water usage data from a sensor unit, and the hub unit being adapted to enclose the wireless receiver,
displaying the data regarding the water use on the hub unit, and
transmitting the data wirelessly from the hub unit to remote data storage.

27. The method of claim 26, wherein the sensor unit comprises the gyroscope.

28. The method of claim 26, wherein the water flow fitting is selected from the group consisting of: plumbing spouts, plumbing fillers, plumbing taps, plumbing necks, plumbing arms, plumbing heads, plumbing roses, shower necks, shower arms, shower heads, shower roses, shower pipes, water pipes and water tanks.

29. The method of claim 26, wherein the displaying shows one or more of: length of time for current water usage, length of time for recent water usage, target time period for water usage, amount of time exceeding the target time period for water usage.

30. The method of claim 26, wherein the displaying is accompanied by an auditory signal indicating one or more of: length of time for current water usage, length of time for recent water usage, target time period for water usage, amount of time exceeding the target time period for water usage.

31. The method of claim 26, wherein the displaying is accompanied by an auditory signal indicting one or more of: length of time for current water usage, length of time for recent water usage, target time period for water usage, amount of time exceeding the target time period for water usage and wherein the audio signal is selected from a voice prompt and an alarm.

32. The method of claim 26, wherein the displaying is accompanied by a visual signal indicating one or more of: amount of time of water usage, target time period for water usage, amount of time exceeding the target time period for water usage.

33. The method of claim 26, wherein the displaying is accompanied by a visual signal indicating one or more of: amount of time of water usage, target time period for water usage, amount of time exceeding the target time period for water usage and wherein the visual signal is selected from one or more of: a colour, a change in colour, a steady light, a flashing light, a symbol, and a picture.

34. The method of claim 26, wherein the electronic device is selected from the group consisting of a smart phone, a tablet, and a PC and wherein the electronic device comprises a program or application software for processing and displaying the data in a user interface and wherein the user interface provides information to the user including one or more of:
length of time for current water usage
length of time for recent water usage
average time of water usage per water use event
length of time of water usage per day, per week, per month, and/or per year
number of water usage events per day, per week, per month, and/or per year
water usage time exceeding a preset value
estimated water cost for water usage
estimated CO₂e from energy
water cost exceeding a preset value
cost of water usage per day, per week, per month, and/or per year
water cost savings per day, per week, per month, and/or per year.

35-60. (canceled)
